(19) United States
(12) Patent Application Publication
(10) Pub. No.: US 2009/0092760 A1
(43) Pub. Date: Apr. 9, 2009

(54) METAL PROTECTANT AND METHOD OF APPLICATION

(76) Inventors: ADAM BRAGER, Red Bank, NJ (US); Matthew Maccia, Bedminster, NJ (US); Alice Hudson, Jupiter, FL (US)

Correspondence Address: AKERMAN SENTERFITT, P.O. BOX 3188, WEST PALM BEACH, FL, 33402-3188, US

(21) Appl. No.: 11/866,835

(22) Filed: Oct. 3, 2007

(51) Int. Cl. B32B 27/04; B05D 3/00; C08L 83/00

(52) U.S. Cl. 427/387; 428/446; 524/1; 524/588; 524/81

(57) ABSTRACT

A protectant for metal surfaces includes a polymer that contains at least one functional groups for adherence to the metal surface and a plurality of functional groups for coupling of the polymers and a volatile solvent that inhibits coupling of the polymers. The protectant can be transferred to the metal surface from a wipe such that the desired surface is selectively wetted with the protectant.

### FIELD OF THE INVENTION

The invention relates to a solution for use as a metal cleaner and protector and to the application of the solution to a metal surface using a wipe.

### BACKGROUND OF THE INVENTION

The maintenance of aluminum and other metal surfaces for structure exposed to sunlight and corrosive conditions has been a long standing problem. For marine watercraft this maintenance is critical to assure the reliability and the aesthetic quality of the vessel. Anodized aluminum also suffers from fading over time. Presently, for long term protection the need is primarily filled with waxes which require timely surface preparation, application and buffing to achieve the desired appearance.

Alternately, a product for the cleaning and protection of aluminum and other metals is available that is primarily an oil. The product is easily sprayed onto the metal surface and requires no buffing, but provides a significantly shorter period of protection to that of waxes displaying limited resistance to washing with detergent. The product also results in a slippery surface that remains slippery for a relatively long period of time. Not only is the surface to which the spray is directed rendered slippery, but also any other surface where the oil happens to wet. This inadvertently results in a hazard when the slick surface is one upon which an individual must travel on a watercraft. Hence there is a need for a metal protectant that is easily applied, can be directed to only the surface where the protectant is desired, and provides a protective coating that can withstand at least some repeated washing with a detergent. It is also desirable that such a protectant does not leave a slippery surface for an extended period of time.

### SUMMARY OF THE INVENTION

A protectant for a metal surface is a hydrophobic polymer which has a plurality of one or more elastomeric repeating units, with at least one functional groups for adherence to a metal surface per polymer, and a plurality of functional groups for coupling between polymers, and a coupling inhibiting solvent that is volatile with a flashpoint of at least 38° C. This protectant, when applied to a metal surface has an affinity for the metal surface provided by the functional groups for adherence and forms a protective coating on the metal upon loss of solvent and reaction of the functional groups for coupling. The solvent inhibits the coupling reaction until a significant portion of the solvent has been lost as a volatile such that the protectant is easily applied to the metal surface and the coupling reaction occurs to a large extent intermolecularly between two polymers rather than intramolecularly between two functional groups for coupling on the same polymer. In one embodiment of the invention the polymer is a polysiloxane where elastomer repeating units are dialkylsiloxane units of the structure R¹R²SiO wherein R¹ and R² are independently C₁ to C₁₈ alkyl or phenyl, the functional groups for coupling are a Si—X group, wherein X is H, OH, OR, or OC(O)R wherein R is independently C₁ to C₄ alkyl, and the functional group for adherence comprises Si(CH₂)ₓNR³R⁴ wherein x is 2 to 8 R³ is H or C₁ to C₄ alkyl, and R⁴ is H, C₁ to C₄ alkyl, or (CH₂CH₂NR⁵₂) where R⁵ is independently H or C₁ to C₄ alkyl, and the solvent comprises a C₁₀ to C₁₆ hydrocarbon or any mixture of C₁₀ to C₁₆ hydrocarbons.

The invention is also directed to a wipe to impart a protective coating to a metal surface where a solution of a hydrophobic polymer that contains a plurality of one or more elastomeric repeating units, at least one functional group for adherence to a metal surface, and one or more coupling functional groups, where the average number of coupling functional groups per polymer is at least 2, in a coupling inhibiting solvent that is volatile with a flashpoint of at least 38° C. This protectant solution wets one or more flexible sheets of a material that is effectively inert to the functional groups for adherence and coupling so that the wipe can be used to apply the protectant nearly exclusively to a desired metal surface. Such a wipe can be wet with the silicone polymer based protectant described in the previous paragraph. The sheets used for the wipes can be nonwoven polypropylene or poly ethylene terepthalate.

The invention is also directed to a method of coating a surface of a metal article by the steps of: providing a wipe wet with a solution of a hydrophobic polymer with a plurality of one or more elastomeric repeating units, one or more functional groups for adherence to a metal surface, and a plurality of coupling functional groups, and a coupling inhibiting solvent which is volatile with a flashpoint of at least 38° C.; contacting the wipe to at least a portion of a surface of a metal article; depositing a film of the solution to the surface; volatilizing the solvent from the film: and coupling the coupling functional groups between polymers. For the wipe wet with a polysiloxane described in the previous paragraph, the contacting with the metal surface involves rubbing the wipe on the surface of the metal article, which transfers the protectant solution to the metal surface. The wipe can be attached to a moving part of mechanical device such as a drill for the application of the protectant to the metal surface.

### BRIEF DESCRIPTION OF THE DRAWINGS

A fuller understanding of the present invention and the features and benefits thereof will be obtained upon review of the following detailed description together with the accompanying drawings, in which:

FIG. 1 shows a graph of the loss of solvent from a filter paper wetted with the protectant of an embodiment of the invention over a 6 hour period and that of a commercially available protectant over the same period of time.

FIG. 2 shows a photograph of a water droplet on an aluminum surface after coating according to an embodiment of the invention after 5 cycles of washing with a detergent and rinsing with water.

### DETAILED DESCRIPTION OF THE INVENTION

The present invention comprises a protectant solution for formation of protective coatings on a metal surface. A coating method comprises the deposition of a plurality of polymers from solution to the metal surface in a controlled manner where upon loss of the solvent the polymers couple into a coating of a significantly higher molecular weight polymer or a polymer network where the polymer contains functional groups which adhere the coating to the metal surface. The metal can be aluminum, stainless steel, brass, chrome, or other metals or metal alloys. The polymer can be any hydrophobic polymer such that an aqueous solution is resisted by the polymer coating. The aqueous solution can be a salt solution, a cleaning solution, or other aqueous solutions that can promote corrosion of the metal surface. The invention is also directed to a system for applying the protectant using a flexible wipe. The surface of the wipe is easily wetted with the solution but does not contain functional groups or absorbed chemicals that react with the polymer to a significant degree. The system employing a wipe permits the selective application of the protectant to a desired metal surface with little, if any, application to other surfaces in the proximity of the desired metal surface.

The protectant comprises a solution of a polymer containing one or more functional groups that have an affinity for a metal surface and promotes the formation of a film of the polymers on the metal surface to promote a uniform coverage of the polymer on the surface and ultimately aid in the adherence of the coating to the metal surface. A plurality of coupling functional groups per polymer molecule are present, which form a higher molecular weight polymer or polymer network on the metal surface after coupling of the functionality. In general the coupling functional groups ultimately form covalent bonds, although the coupling functional groups can be functional groups that couple by electrostatic interactions or complexation. In general the coupling functional groups is, but is not required to be, a different functional groups than the functional groups that has the affinity for the metal surface. The coupling functional groups can be a single functional group that undergoes self coupling or can be two or more different functional groups that undergoes coupling where any functional groups group can couple with any other functional group or where there are one or more pairs of complementary functional groups for coupling present. The coupling reaction can require a catalyst, initiator, or promoter. Complementary functional groups can be exclusively present on different polymer molecules. The coupling occurs to an appreciable extent only after application to the metal surface. The solvent provides a vehicle for the deposition of the polymers on the surface and inhibits the coupling of the functional groups on the polymers such that the polymers can readily conform to the surface and undergo a significant proportion of the coupling reaction after the solvent has evaporated to a large extent, for example more than 50 percent. In this manner, because a large proportion of the coupling reaction occurs where the solvent has evaporated, intermolecular coupling between polymer molecules is favored over intramolecular reaction between coupling functional groups on a single polymer so that the molecular weight of the polymer increases after it has been applied to the surface. In the limit, the final coating can be a network at a sufficiently high degree of coupling. In addition to the polymer and solvent, antioxidants, preservatives, UV absorbers and catalysts can be included in the protectant.

The solvent can inhibit the coupling reaction by any mechanism. For example, in one embodiment of the invention the coupling functional groups can be a polymerizable group, such as an olefin, where the concentration of the group is below a floor concentration for polymerization unless: it concentrates at the metal surface due to the adhering functional groups; it concentrates due to solvent loss as a volatile; or both metal surface concentration or concentration due to volatile solvent loss has occurred. In another embodiment the solvent contains functional groups that inhibit an active species for the coupling reaction, for example radicals when the coupling occurs via a radical mechanism, such that the coupling only occurs after a significant proportion of the solvent is lost.

In another embodiment the solution can contain a dissolved catalyst where the rate dependence of the coupling reaction on the catalyst concentration is greater than first order such that the loss of 90 percent or even 99 percent of the solvent is required before the catalyst concentration is sufficiently high to achieve a rapid rate of coupling. In this embodiment of the invention the concentration of the polymers will also be high before much coupling occurs such that the proportion of intermolecular reaction to intramolecular reaction is high.

In one embodiment of the invention the solvent can inhibit the absorption of a coupling group activating species or co-reactant from the environment where the solution is applied to the metal surface such that the activating species or co-reactant does not achieve a level that promotes reaction to a significant degree, for example less than about 66 percent reaction when there are three coupling functional groups per polymer, until a sufficient amount of the solvent has been lost, for example 80 percent of the solvent or more. In one embodiment the activating species or co-reactant can be water and the solvent can be a hydrophobic solvent such that the level of water absorbed from the atmosphere is very low until a large proportion of the solvent is lost. The retardation of the coupling reaction by the absence of sufficient activating species or co-reactant until the polymer concentration is high promotes intermolecular coupling over intramolecular coupling.

It is desirable that the cured coating act as an elastomer, so that the growing or final polymer or polymer network of the coating is above its glass transition temperature so that the coupling reaction is not quenched by the formation of a glass. The repeating units of such a polymer for the purposes of this invention are referred to as elastomeric in that the final polymer or network will have a glass transition temperature below the ambient temperature used for film formation and coupling, which in general are between 0 and 40° C. The polymer can be of a type, which in the absence of solvent, displays a glass transition temperature below the temperature for film formation, but curing of the polymer in the presence of residual solvent during the coupling reaction is not in a glassy state. It can be advantageous that the final polymer or network of the coating is elastomeric in this sense such that no cracking of the coating, no delamination of the coating from the surface, and no local loss of adhesion to the metal surface occurs resulting in failure of the coating to protect the metal surface from the environment due to forces imposed by a thermal expansion mismatch between a glassy polymer and a metal.

The polymers useful for the present invention are generally hydrophobic polymers which will repel aqueous solutions. These polymers can include various hydrocarbon polymers such as polystyrenes, polyolefins, polydienes, polyesters, and silicones including copolymers of hydrophobic repeating units. In all cases the polymer must be one where some combination of repeating units and chain-ends contain adhering functional groups and coupling functional groups. All polymers for the protectant can be considered to be copolymers, although the number of co-repeating units for the adhesive and coupling functional groups can be small, as low as about 1 percent depending upon the molecular weight of the polymer. Those skilled in the art can design such polymers which contain the coupling and adhering functional groups by a variety of methods including the use of specifically functionalized comonomers and modification of the polymers after formation.

In one embodiment of the invention, the polymer is a silicone. The use of a silicone is advantageous in that it has an inherently low glass transition temperature, has a low surface energy, and a low affinity for water and ionic species, such as water and salt. Various functional groups for coupling can be bonded to the silicon backbone. The silicone polymer can be adhered to the metal surface by functional groups ultimately connected to the silicone backbone of the polymer which are known to bind to the metal by any polar, electrostatic, metal or metal ion complexation, or any other attractive mode between the adhering functional groups and the metal or a metal oxide surface of the metal article that is generally greater than a van der waal interaction or induced dipole interaction between the repeating units of the polymer and the repeating units of the polymer and/or the solvent. Because the final coating will contain many of these adhering groups, the equilibrium constant for binding of an isolated adhering group to the metal surface need not be large. Due to the linking of multiple adhering groups in a final coating polymer or network, the combined equilibrium constant can be sufficiently large to anchor the coating to the metal. The partitioning of the adhering groups to the metal surface is enhanced in the developing coating by the germane choice of a solvent. In this embodiment of the invention, the solvent can be a hydrocarbon such that the solvent does not effectively compete for the metal's surface or for the adhering group.

The silicone polymer can have repeating units comprising dialkylsiloxane units of the structure R¹R²SiO where R¹ and R² are independently C₁ to C₁₈ alkyl or phenyl. The silicone polymer can be a copolymer where two or more different R¹R²SiO with different R¹ and R² groups. The coupling functional groups can be from a Si—X group, wherein X is H, OH, OR, or OC(O)R, where R is independently C₁ to C₄ alkyl. Different coupling functional groups can be included in a single silicone polymer. These functional groups can be hydrolyzed upon absorption of water and subsequently condensed to couple the polymer into a higher molecular weight polymer or even a network when the concentration of the polymer is sufficient for preferential intermolecular condensation over intramolecular condensation. The functional groups for adherence can be Si(CH₂)ₓNR³R⁴ where x is 2 to 8 and R³ is H or C₁ to C₄ alkyl, R⁴ is H, C₁ to C₄ alkyl, or (CH₂CH₂NR⁵₂) where R⁵ is independently H or C₁ to C₄ alkyl. Other functional groups for adherence will be obvious to those of ordinary skill in the art and can be optimized for adherence to a desired metal. Such polymers can be readily prepared by one skilled in the art using any of a variety of condensation and ring-opening polymerization approaches. The adhering functional groups and the coupling functional groups can be attached to the same or different Si atoms of the polymer. A number of polymers which can be used for this embodiment of the invention are commercially available. One such polymer is available as Dow Corning® 536 Fluid, available from Dow Corning Corporation of Midland Mich. The Fluid comprises a polydimethylsiloxane with a viscosity of about 40 cSt and a specific gravity of 0.985 where Si—X groups consist of SiOCH₃ generally with some SiOH groups present.

Solvents that can be used with the silicone polymers of this embodiment of the invention are those that: are hydrophobic such that water is effectively insoluble in the polymer solution; are sufficiently volatile to allow a high degree of evaporation of the solvent from the polymer film in an acceptable period of time; and have a sufficiently high flash point and low toxicity to be applied safely by a technician. Generally hydrocarbons are good solvents for silicone polymer allowing the contacting and deposition of a low viscosity solution to the metal surface. Although a high polymer concentration can be used, a dilute solution more easily permits the formation of a thin coating on the metal surface. Generally the concentration of the silicone polymer should be at least 1 to about 10 percent by weight. In one embodiment of the invention the polymer is present in solution at a level of 1.5 to 3 percent. As the coupling of the polymer requires water, the hydrocarbon should have sufficient volatility but be highly hydrophobic such that the solvent can be lost before coupling proceeds to a large extent, promoting the intermolecular coupling reaction between polymers over the intramolecular coupling reaction within a single polymer. The hydrocarbon solvent must be volatile and should have a high flash point, greater than 38° C. (100° F.) and generally greater than 60° C. The high flash point is desirable for safe handling of the solution and also because such hydrocarbons display the advantageous water excluding ability. The hydrocarbons with flash points in excess of 38° C. are decane, C₁₀H₂₂, and higher molecular weight hydrocarbons. These solvents also dissolve water to a lesser extent than do lower molecular weight hydrocarbons. This is particularly advantageous when the ambient air in contact with the freshly applied protectant has a high level of humidity, as is common on a floating watercraft. Hydrocarbons larger than about C₁₆H₃₄ are insufficiently volatile to evaporate sufficiently in a reasonable rate of time, for example overnight, when applied to a surface during the evening under normal ambient conditions one would experience on a watercraft. This inability to evaporate readily is one of the disadvantages of state of the art mineral oil based protectants leading to slippery surfaces for a long period of time. The hydrocarbon solvent of an embodiment of the invention are individually, or a mixture of, C₁₀ to C₁₆ hydrocarbons for example a mixture of C₁₁ to C₁₅ aliphatic hydrocarbons.

Other components can be included in the silicone polymer-hydrocarbon solutions of an embodiment of the invention. Other compounds such as antioxidants, preservatives, UV absorbers and catalysts can be included in the solution. Additional low volatility silicones or other silanes that contain multiple coupling functional groups can be included to increase the connectivity of the final silicone polymer.

The material used for a flexible wipe according to an embodiment of the invention is one that does not react or bind (is essentially inert) with a significant portion of the polymer in solution or promote coupling of the polymer's coupling functional groups or transformation of the polymer's metal adhering functional groups. The material of the wipe is chosen such that the coupling reaction does not occur prematurely in the wipe to an extent that the polymer does not readily transfer to the metal surface and such that the polymer is not transformed in any manner that limits the degree of coupling or adherence of the polymers to the metal surface after deposition. The wipe can be a synthetic based material, for example, a non-woven polypropylene or polyethylene terapthalate for the silicone polymer based protectant embodiment described above. For an embodiment where the polymer is a silicone, polypropylene and poly ethylene terephthalate wipes have the desired characteristics of having a very low levels of water as received from a manufacturer and no functional groups in the wipe that readily react with the coupling functional groups or the adhering functional groups of the protectant. Low levels of moisture in the wipes and solvent permit the storage of the silicone polymer solution for long times between manufacture and use. The use of such hydrophobic wipes and solvents allows for preparation of the silicone polymer solution containing wipes without the need for dry atmospheres during their fabrication.

The use of a wipe allows the selective application of the polymer solution to almost exclusively the desired metal surface, with little or no transfer of the solution to an area that the presence of the solution would cause a slipping or other hazard when the solution is transferred by the normal method of drawing a wipe over a surface. The ability to direct the solution to only the desired surface is in contrast to application as a spray, where the delivery is over a spray cross section that will frequently exceed the cross section of the article to be coated. Application via a wipe is also advantageous over that using a brush, where control of the quantity of solution is difficult and often results in the splashing and dripping of liquid that is being applied to non-intended surfaces to which application is, at best, wasteful of the protectant or, at worst, dangerous to the individuals traversing that surface. By the use of a wipe, even one saturated with the solution, transfer of the solution can be effectively restricted to the area where the wipe contacts the surface of the article to be coated.

The wipes can be packaged as a series of individual or multiple sheets or a continuous sheet such as a roll where individual wipes can be torn or cut from the roll. Perforations can be formed on the continuous sheet such that a sheet of a predetermined size can be selectively torn from the roll. The housing for the wipes can be for individual sheets or for multiple sheets. When packaged as multiple sheets, the housing of the package should be effectively resealable such that the unused wipes can retain their solvent during storage.

It should be understood that the Examples described below are provided for illustrative purposes only and do not in any way define the scope of the invention.

### EXAMPLES

### Preparation of a Wipe

A polymer solution was prepared by the mixing 2 percent by weight Dow Corning® 536 Fluid, 0.1 percent of the UV absorber, Cyasorb 5411, 0.1 percent of the preservative BHT, and 97.8 percent Isopar L™ from Exxon Company, U.S.A., Houston Tex. The solution was then applied to nonwoven polyethylene terephthalate wipes by pouring the solution into the center of a cylindrical polyethylene housing containing a roll of wipes perforated to allow the separation of single wipes when dispensing from the center of the roll. Approximately 3.5 g of the solution was absorbed per gram of wipe.

### Application to an Anodized Aluminum Piping Manufactured for Marine Applications

A wipe dispensed from the container described above, containing approximately 7 g of solution was manually rubbed over the surface of a section of anodized aluminum piping where the luster imparted by the transferred solution obviated the surface that had been contacted from that which had not been contacted by the solution. The rubbing procedure was continued until the entire surface to be coated displayed a luster.

For comparison a virgin polyethylene terephthalate wipe was sprayed with a commercially available mineral oil based metal protectant marketed for marine environments as Aluma Guard™ from Rupp Marine Inc., Port Salerno, Fla. Again, the portion of the anodized aluminum surface contacted with the protectant was clearly delineated by the luster that resulted by contact.

### Volatile Loss and Coating Formation

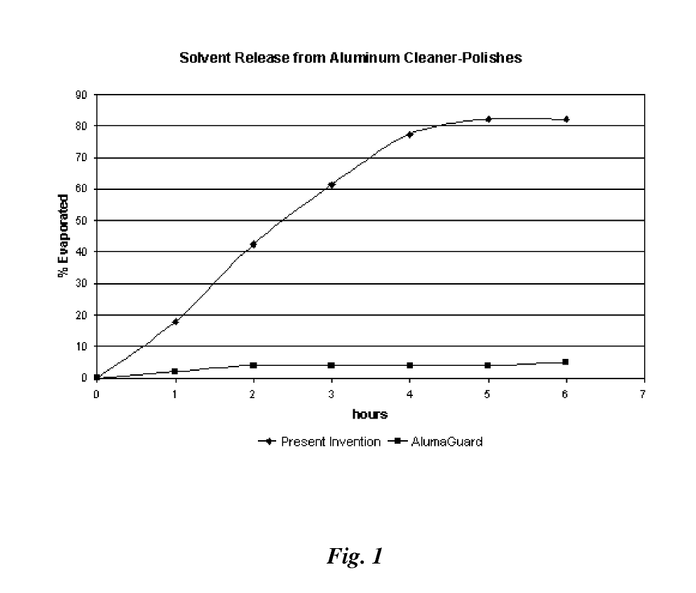

To determine the loss of volatiles from the polymer solution, a 1.0 g portion of the polymer solution was applied to a 15 cm Whatman #1 cellulose filter paper placed on a watch glass. At ambient room conditions the mass loss was followed by weighing the watch glass and its contents every hour over a 6 hour period using an analytical balance. The mass loss was converted into a percent of the solution evaporated and plotted against time as can be seen in FIG. 1. The percent loss proceeded in a linear manner over a period of about 4 hours at which time the loss slowed dramatically with little change in mass observed after 5 hours, when approximately 82 percent of the 1.0 g of solution applied to the filter paper had evaporated.

For comparison a 1.0 g portion of Aluma Guard™protectant was applied to a paper on a watchglass and the mass loss was followed over a 6 hour period. The most significant mass loss over the first two hours when approximately 4 percent of the 1.0 g of solution applied to the filter paper had evaporated. A mass loss of less than 5 percent occurred over 6 hours.

### Resistance to Detergent

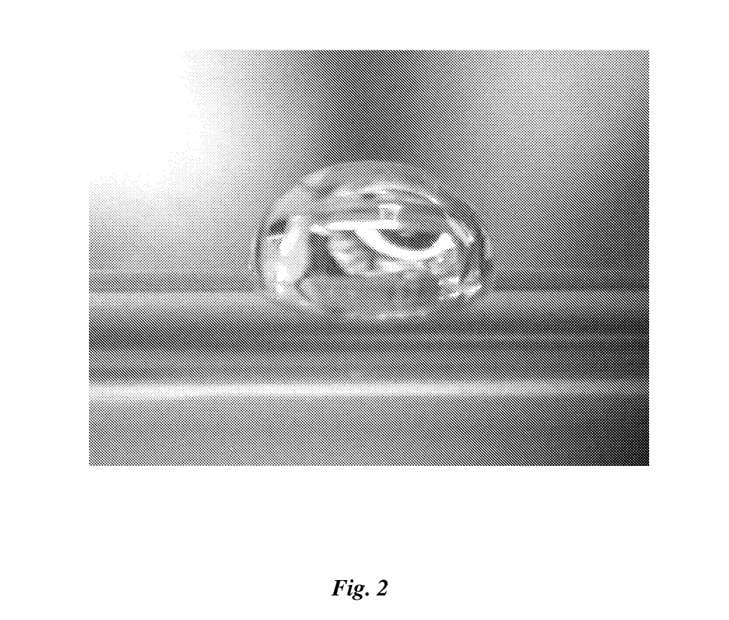

Aluminum piping samples that had been contacted with either the polymer solution of the invention or the Aluma Guard™ protectant were exposed to the atmosphere at normal room temperatures overnight, which in both cases left a surface with a clean and shinny appearance. The Aluma Guard™ contacted surface remained oily to the touch. The contact angles of a drop of water on the two surfaces were measured. Both displayed a high contact angle, in excess of 90° at that time. Both sample surfaces were then washed using Salt Away™ boat detergent, Salt Away Products, Inc., Santa Ana, Calif. The washing was carried out by spraying the detergent until the surface was thoroughly wetted followed by rinsing thoroughly with tap water. The washing process was repeated five times. Both samples remained clean and shiny in appearance. The contact angle on the surface with the coating of an embodiment of the invention, as shown in FIG. 2, remained at a contact angle in excess of 90°. In contrast the contact angle for the sample contacted with the Aluma Guard™ protectant had reduced to 35° indicating significant loss of the material.

### Salt Spray and Sunlight Resistance

Aluminum pipings that had been contacted with either the polymer solution of the invention or the Aluma Guard™ protectant were exposed to the atmosphere at normal room temperatures overnight which in both cases left a surface with a clean and shinny appearance. The contact angles of a drop of water on the two surfaces were measured. Both sample surfaces displayed a high contact angle, in excess of 90° at that time. Both samples were positioned 15-20 inches below a 275 Watt Sunlight Lamp in a chamber. The temperature in the chamber was 104° F. The surfaces of the samples were sprayed with a 5 percent sodium chloride solution three times a day at 4 hour intervals. Once a day the surfaces were rinsed with tap water and air dried and the contact angle and surface appearance was noted. The tests were continued until a measurable decrease in the contact angle and deterioration in the appearance was noted. The surfaces with the coating of the embodiment of the invention required 15 cycles of 24 hour sunlight exposure and 3 salt spray applications before deterioration occurred. In contrast the Aluma Guard™ protectant sample displayed deterioration after only 12 cycles.

It is to be understood that while the invention has been described in conjunction with the preferred specific embodiments thereof, that the foregoing description as well as the examples which followed are intended to illustrate and not limit the scope of the invention. Other aspects, advantages and modifications within the scope of the invention will be apparent to those skilled in the art to which the invention pertains.

We claim:

1. A protectant for a metal surface comprising:
a hydrophobic polymer comprising a plurality of one or more elastomeric repeating units, at least one functional groups for adherence to a metal surface, and a plurality of functional groups for coupling; and
a coupling inhibiting solvent wherein said solvent is volatile with a flashpoint of at least 38° C.

2. The protectant of claim 1, wherein said elastomer repeating units comprise dialkylsiloxane units of the structure R¹R²SiO wherein R¹ and R² are independently C₁ to C₁₈ alkyl or phenyl.

3. The protectant of claim 1, wherein said coupling functional groups comprises a Si—X group, wherein X is H, OH, OR, or OC(O)R wherein R is independently C₁ to C₄ alkyl.

4. The protectant of claim 1, wherein said functional group for adherence comprises Si(CH₂)ₓNR³R⁴ wherein x is 2 to 8 R³ is H or C₁ to C₄ alkyl, and R⁴ is H, C₁ to C₄ alkyl, or (CH₂CH₂NR⁵₂) where R⁵ is independently H or C₁ to C₄ alkyl.

5. The protectant of claim 1, wherein said polymer comprises polydimethylsiloxane, wherein said functional groups for adherence comprises Si(CH₂)₃NH(CH₂)₂NH₂ and wherein said functional groups for coupling comprises SiOCH₃, SiOH or a combination thereof.

6. The protectant of claim 1, wherein said solvent comprises a C₁₀ to C₁₆ hydrocarbon or any mixture of C₁₀ to C₁₆ hydrocarbons.

7. A wipe to impart a protective coating to a metal surface comprising:
a solution of a hydrophobic polymer comprising a plurality of one or more elastomeric repeating units, at least one functional group for adherence to a metal surface, and one or more functional groups for coupling where the average number of functional groups for coupling per polymer is at least 2, and a coupling inhibiting solvent wherein said solvent is volatile with a flashpoint of at least 38° C.; and
one or more flexible sheets comprising a material that is inert to said functional groups for adherence and said coupling functional groups wherein said sheet is wetted by said solution.

8. The wipe of claim 7, wherein said elastomer repeating units comprise dialkylsiloxane units of the structure R¹R²SiO wherein R¹ and R² are independently C₁ to C₁₈ alkyl or phenyl, said functional groups for coupling comprises a Si—X group, wherein X is H, OH, OR, or OC(O)R wherein R is independently C₁ to C₄ alkyl, and wherein said functional groups for adherence comprises Si(CH₂)ₓNR³R⁴ wherein x is 2 to 8 R³ is H or C₁ to C₄ alkyl, and R⁴ is H, C₁ to C₄ alkyl, or (CH₂CH₂NR⁵₂) where R⁵ is independently H or C₁ to C₄ alkyl.

9. The wipe of claim 8, wherein said polymer comprises polydimethylsiloxane, wherein said functional groups for adherence comprises Si(CH₂)₃NH(CH₂)₂NH₂ and wherein said coupling functional groups comprises SiOCH₃, SiOH or a combination thereof.

10. The system of claim 7, wherein said solvent comprises a C₁₀ to C₁₆ hydrocarbon or any mixture of C₁₀ to C₁₆ hydrocarbons.

11. The wipe of claim 7, wherein said sheet comprises a nonwoven polypropylene or poly ethylene terepthalate.

12. A method of coating a surface of a metal article comprising the steps of:
providing a wipe wet with a solution of a hydrophobic polymer comprising a plurality of one or more elastomeric repeating units, one or more functional groups for adherence to a metal surface, and a plurality of functional groups for coupling, and a coupling inhibiting solvent wherein said solvent is volatile with a flashpoint of at least 38° C.;
contacting said wipe to at least a portion of a surface of a metal article;
depositing a film of said solution to said surface;
volatilizing said solvent from said film, and
coupling said functional groups for coupling between polymers.

13. The method of claim 12, wherein said elastomer repeating units comprise dialkylsiloxane units of the structure R¹R²SiO wherein R¹ and R² are independently C₁ to C₁₈ alkyl or phenyl, said coupling functional groups comprises a Si—X group, wherein X is H, OH, OR, or OC(O)R wherein R is independently C₁ to C₄ alkyl, and wherein said functional groups for adherence comprises Si(CH₂)ₓNR³R⁴ wherein x is 2 to 8 R³ is H or C₁ to C₄ alkyl, and R⁴ is H, C₁ to C₄ alkyl, or (CH₂CH₂NR⁵₂) where R⁵ is independently H or C₁ to C₄ alkyl.

14. The method of claim 13, wherein said polymer comprises polydimethylsiloxane, wherein said functional groups for adhering comprises Si(CH₂)₃NH(CH₂)₂NH₂ and wherein said functional groups for coupling comprises SiOCH₃, SiOH or a combination thereof.

15. The method of claim 14, wherein said step of coupling includes activating said functional groups for coupling comprising the steps of:
absorbing moisture; and
hydrolyzing at least some of said coupling functional groups to promote coupling.

16. The method of claim 14, wherein said solvent comprises a C₁₀ to C₁₆ hydrocarbon or any mixture of C₁₀ to C₁₆ hydrocarbons.

17. The method of claim 14, wherein said wipe comprises a nonwoven polypropylene or poly ethylene terephthalate sheet.

18. The method of claim 14, wherein said step of contacting comprises manually rubbing said wipe on said surface of said metal article.

19. The method of claim 14, wherein said step of contacting comprises moving said wipe attached to a rotating or oscillating arm of a mechanical device over said surface.

20. The method of claim 19, wherein said device is a drill.
